(19) United States
(12) Patent Application Publication
(10) Pub. No.: US 2020/0183497 A1
(43) Pub. Date: Jun. 11, 2020

(54) OPERATION METHOD AND APPARATUS FOR SERVICE OBJECT, AND ELECTRONIC DEVICE

(71) Applicant: BEIJING SENSETIME TECHNOLOGY DEVELOPMENT CO., LTD, Beijing (CN)

(72) Inventors: Fan ZHANG, Beijing (CN); Binxu PENG, Beijing (CN); Kaijia CHEN, Beijing (CN)

(73) Assignee: BEIJING SENSETIME TECHNOLOGY DEVELOPMENT CO., LTD, Beijing (CN)

(21) Appl. No.: 16/314,333

(22) PCT Filed: Dec. 26, 2017
(86) PCT No.: PCT/CN2017/118706

§ 371 Date: Dec. 28, 2018

(30) Foreign Application Priority Data
Dec. 27, 2016 (CN) 201611227749.5

(51) Int. Cl. G06F 3/01; G06F 3/0484; A63F 13/213

(52) U.S. Cl. CPC G06F 3/017; G06F 3/011; A63F 2300/1087; A63F 13/213; G06F 2203/04803; G06F 3/0484

(57) ABSTRACT

A method and an apparatus for operating a service object, and an electronic device include: obtaining first person's behavior data; generating a first service object control instruction corresponding to the first person's behavior data; and sending the first service object control instruction to a second terminal, so that the second terminal displays a service object based on the first service object control instruction; receiving a first service object control instruction sent by a first terminal; generating a second service object control instruction corresponding to second person's behavior data, the second person's behavior data being obtained by the second terminal; and displaying a service object based on the first service object control instruction and the second service object control instruction; thereby enriching the interaction modes between terminals, improving interaction flexibility, and satisfying interaction requirements for a first terminal user and/or a second terminal user.

### CROSS-REFERENCE TO RELATED APPLICATION

The present disclosure claims priority to Chinese Patent Application No. 201611227749.5, filed on Dec. 26, 2016 and entitled “OPERATION METHOD AND APPARATUS FOR SERVICE OBJECT, AND ELECTRONIC DEVICE,” the disclosure of which is hereby incorporated by reference in its entirety.

### TECHNICAL FIELD

Embodiments of the present disclosure relate to artificial intelligence technologies, and in particular, to a method and an apparatus for operating a service object, and an electronic device.

### BACKGROUND

With the development of Internet technology, texts, pictures, etc. can be displayed on a live video platform in the form of a video. Terminals on the live video platform are usually classified into host terminals and fan terminals, host terminal users are usually referred to as hosts, and fan terminal users are usually referred to as fans.

### SUMMARY

Embodiments of the present disclosure provide the technical solutions for service object operation.

A method for operating a service object provided according to an aspect of the embodiments of the present disclosure, for use in a first terminal, includes: obtaining first person's behavior data; generating a first service object control instruction corresponding to the first person's behavior data; and sending the first service object control instruction to a second terminal, so that the second terminal displays a service object based on the first service object control instruction.

According to one or more embodiments of the present disclosure, the obtaining the first person's behavior data includes: obtaining the first person's behavior data by a data acquisition apparatus, the data acquisition apparatus including: a data acquisition apparatus of a first terminal, or a data acquisition apparatus of a smart device associated with the first terminal.

According to one or more embodiments of the present disclosure, the data acquisition apparatus includes any one or any combination of: a video image acquisition apparatus, an infrared data acquisition apparatus, and an ultrasonic data acquisition apparatus; the video image acquisition apparatus includes a camera of the first terminal.

According to one or more embodiments of the present disclosure, before the obtaining the first person's behavior data, the method further includes: receiving a data acquisition apparatus enabling request sent by the second terminal; the obtaining the first person's behavior data includes: obtaining the first person's behavior data when a user confirmation operation based on the data acquisition apparatus enabling request is detected.

According to one or more embodiments of the present disclosure, the generating a first service object control instruction corresponding to the first person's behavior data includes: determining whether the first person's behavior data matches trigger data for a preset service object starting instruction; and generating the first service object control instruction when the first person's behavior data matches the trigger data for the preset service object starting instruction.

According to one or more embodiments of the present disclosure, the first person's behavior data includes any one or any combination of: body movement data, gesture movement data, facial movement data, and facial expression data.

According to one or more embodiments of the present disclosure, the service object includes a game.

Another method for operating a service object further provided according to another aspect of the embodiments of the present disclosure, for use in a second terminal, includes: receiving a first service object control instruction sent by a first terminal; generating a second service object control instruction corresponding to second person's behavior data, the second person's behavior data being obtained by the second terminal; and displaying a service object based on the first service object control instruction and the second service object control instruction.

According to one or more embodiments of the present disclosure, the displaying a service object based on the first service object control instruction and the second service object control instruction includes: obtaining a first operation result corresponding to the first service object control instruction, and a second operation result corresponding to the second service object control instruction; and displaying the first operation result and the second operation result.

According to one or more embodiments of the present disclosure, the method further includes: displaying first behavior data and second behavior data, the first behavior data being behavior data corresponding to the first operation result, and the second behavior data being behavior data corresponding to the second operation result.

According to one or more embodiments of the present disclosure, the method further includes: displaying the service object and a current video image in a split-screen manner; or displaying the service object and the current video image in a picture-in-picture manner, the display size of the current video image being less than that of the service object.

According to one or more embodiments of the present disclosure, the method further includes: obtaining the second person's behavior data by a data acquisition apparatus, the data acquisition apparatus including: a data acquisition apparatus of a second terminal, or a data acquisition apparatus of a smart device associated with the second terminal.

According to one or more embodiments of the present disclosure, the data acquisition apparatus includes any one or any combination of: a video image acquisition apparatus, an infrared data acquisition apparatus, and an ultrasonic data acquisition apparatus; the video image acquisition apparatus includes a camera of the second terminal.

According to one or more embodiments of the present disclosure, before the receiving a first service object control instruction sent by a first terminal, the method further includes: sending a data acquisition apparatus enabling request to the first terminal, the data acquisition apparatus enabling request being used for enabling a data acquisition apparatus corresponding to the first terminal.

According to one or more embodiments of the present disclosure, the generating a second service object control instruction corresponding to second person's behavior data includes: determining whether the second person's behavior data matches a preset control behavior for the service object; and generating the second service object control instruction when the second person's behavior data matches the preset control behavior for the service object.

According to one or more embodiments of the present disclosure, the second person's behavior data includes any one or any combination of: body movement data, gesture movement data, facial movement data, and facial expression data.

According to one or more embodiments of the present disclosure, the service object includes a game.

An apparatus for operating a service object provided according to still another aspect of the embodiments of the present disclosure, for use in a first terminal, includes: a first obtaining module, configured to obtain first person's behavior data; a first generating module, configured to generate a first service object control instruction corresponding to the first person's behavior data; and a first sending module, configured to send the first service object control instruction to a second terminal, so that the second terminal displays a service object based on the first service object control instruction.

According to one or more embodiments of the present disclosure, the first obtaining module includes: a first obtaining sub-module, configured to obtain the first person's behavior data by a data acquisition apparatus; the data acquisition apparatus includes: a data acquisition apparatus of a first terminal, or a data acquisition apparatus of a smart device associated with the first terminal.

According to one or more embodiments of the present disclosure, the data acquisition apparatus includes any one or any combination of: a video image acquisition apparatus, an infrared data acquisition apparatus, and an ultrasonic data acquisition apparatus; the video image acquisition apparatus includes a camera of the first terminal.

According to one or more embodiments of the present disclosure, the apparatus further includes: a first receiving module, configured to receive, before the first obtaining module obtains first person's behavior data, a data acquisition apparatus enabling request sent by the second terminal; the first obtaining module includes: a second obtaining sub-module, configured to obtain the first person's behavior data when a user confirmation operation based on the data acquisition apparatus enabling request is detected.

According to one or more embodiments of the present disclosure, the first generating module includes: a first data determining sub-module, configured to determine whether the first person's behavior data matches trigger data for a preset service object starting instruction; and a first instruction generating sub-module, configured to generate the first service object control instruction when the first person's behavior data matches the trigger data for the preset service object starting instruction.

According to one or more embodiments of the present disclosure, the first person's behavior data includes any one or any combination of: body movement data, gesture movement data, facial movement data, and facial expression data.

According to one or more embodiments of the present disclosure, the service object includes a game.

An apparatus for operating a service object provided according to yet another aspect of the embodiments of the present disclosure, for use in a second terminal, includes: a second receiving module, configured to receive a first service object control instruction sent by a first terminal; a second generating module, configured to generate a second service object control instruction corresponding to second person's behavior data, the second person's behavior data being obtained by the second terminal; and a service object displaying module, configured to display a service object based on the first service object control instruction and the second service object control instruction.

According to one or more embodiments of the present disclosure, the service object displaying module includes: an operation result obtaining sub-module, configured to obtain a first operation result corresponding to the first service object control instruction, and a second operation result corresponding to the second service object control instruction; and an operation result displaying sub-module, configured to display the first operation result and the second operation result.

According to one or more embodiments of the present disclosure, the apparatus further includes: a behavior data displaying module, configured to display first behavior data and second behavior data, the first behavior data being behavior data corresponding to the first operation result, and the second behavior data being behavior data corresponding to the second operation result.

According to one or more embodiments of the present disclosure, the apparatus further includes: a service object and video image displaying module, configured to display the service object and a current video image in a split-screen manner; or to display the service object and the current video image in a picture-in-picture manner, the display size of the current video image being less than that of the service object.

According to one or more embodiments of the present disclosure, the apparatus further includes: a second obtaining module, configured to obtain the second person's behavior data by a data acquisition apparatus; the data acquisition apparatus is a data acquisition apparatus of a second terminal, or a data acquisition apparatus of a smart device associated with the second terminal.

According to one or more embodiments of the present disclosure, the data acquisition apparatus includes any one or any combination of: a video image acquisition apparatus, an infrared data acquisition apparatus, and an ultrasonic data acquisition apparatus; the video image acquisition apparatus includes a camera of the second terminal.

According to one or more embodiments of the present disclosure, the apparatus further includes: a second sending module, configured to send, before the second receiving module receives a first service object control instruction sent by a first terminal, a data acquisition apparatus enabling request to the first terminal, the data acquisition apparatus enabling request being used for enabling a data acquisition apparatus corresponding to the first terminal.

According to one or more embodiments of the present disclosure, the second generating module includes: a second data determining sub-module, configured to determine whether the second person's behavior data matches a preset control behavior for the service object; and a second instruction generating sub-module, configured to generate the second service object control instruction when the second person's behavior data matches the preset control behavior for the service object.

According to one or more embodiments of the present disclosure, the second person's behavior data includes any one or any combination of: body movement data, gesture movement data, facial movement data, and facial expression data.

According to one or more embodiments of the present disclosure, the service object includes a game.

An electronic device further provided according to yet another aspect of the embodiments of the present disclosure includes a processor and a memory;

the memory is configured to store at least one executable instruction, where the executable instruction enables the processor to perform corresponding operations of the method for operating a service object according to any one of the embodiments described above.

An electronic device further provided according to yet another aspect of the embodiments of the present disclosure includes a processor and a memory;

the memory is configured to store at least one executable instruction, where the executable instruction enables the processor to perform corresponding operations of another method for operating a service object according to any one of the embodiments described above.

Another electronic device further provided according to yet another aspect of the embodiments of the present disclosure includes:

a processor and the apparatus for operating a service object according to any one of the embodiments of the present invention;

when the processor runs the apparatus for operating a service object, the units in the apparatus for operating a service object according to any one of the embodiments of the present invention are run.

Yet another electronic device further provided according to yet another aspect of the embodiments of the present disclosure includes:

a processor and the another apparatus for operating a service object according to any one of the embodiments of the present invention;

when the processor runs the apparatus for operating a service object, the units in another apparatus for operating a service object according to any one of the embodiments of the present invention are run.

A computer program further provided according to yet another aspect of the embodiments of the present disclosure includes a computer-readable code, where when the computer-readable code is running on a device, a processor in the device executes instructions for implementing the steps of the method for operating a service object according to any one of the foregoing embodiments of the present invention.

A computer-readable storage medium further provided according to yet another aspect of the embodiments of the present disclosure is configured to store computer-readable instructions, where when the instructions are executed, the operations in the steps of the method for operating a service object according to any one of the foregoing embodiments of the present invention are implemented.

In the technical solutions provided in the embodiments of the present disclosure, first person's behavior data is obtained on a first terminal, the first person's behavior data being person's behavior data of a first terminal user, a first service object control instruction corresponding to the first person's behavior data is generated, and the first service object control instruction is sent to a second terminal, so that the second terminal displays a service object based on the first service object control instruction, thereby implementing generation and sending of the first service object control instruction on the first terminal. A first service object control instruction is received on a second terminal, second person's behavior data is obtained, a second service object control instruction corresponding to second person's behavior data is generated, and a service object is displayed based on the first service object control instruction and the second service object control instruction. According to the embodiments of the present disclosure, by sending the first service object control instruction to the second terminal from the first terminal, an interaction process of displaying the service object by the second terminal according to the received first service object control instruction and the generated second service object control instruction is implemented, thereby implementing intelligent interaction between the first terminal and the second terminal, enriching the interaction modes between terminals, improving interaction flexibility, and satisfying interaction requirements for a first terminal user and/or a second terminal user.

The following further describes in detail the technical solutions of the present disclosure with reference to the accompanying drawings and embodiments.

### BRIEF DESCRIPTION OF THE DRAWINGS

The accompanying drawings constituting a part of the specification are used for describing embodiments of the present disclosure and are intended to explain the principles of the present disclosure together with the descriptions.

According to the following detailed descriptions, the present disclosure can be understood more clearly with reference to the accompanying drawings.

FIG. 1 is a flowchart of a method for operating a service object according to an embodiment of the present disclosure.

FIG. 2 is a flowchart of another method for operating a service object according to an embodiment of the present disclosure.

FIG. 3 is a flowchart of still another method for operating a service object according to an embodiment of the present disclosure.

FIG. 4 is a flowchart of yet another method for operating a service object according to an embodiment of the present disclosure.

FIG. 5 is a flowchart of still yet another method for operating a service object according to an embodiment of the present disclosure.

FIG. 6 is a structural block diagram of an apparatus for operating a service object according to an embodiment of the present disclosure.

FIG. 7 is a structural block diagram of another apparatus for operating a service object according to an embodiment of the present disclosure.

FIG. 8 is a structural block diagram of still another apparatus for operating a service object according to an embodiment of the present disclosure.

FIG. 9 is a structural block diagram of yet another apparatus for operating a service object according to an embodiment of the present disclosure.

FIG. 10 is a schematic structural diagram of an application embodiment of an electronic device according to an embodiment of the present disclosure.

### DETAILED DESCRIPTION

The optional implementation modes of the embodiments of the present disclosure are further described exemplarily below with reference to the accompanying drawings (the same reference numerals in a plurality of accompanying drawings represent the same elements) and the embodiments. The following embodiments are intended to illustrate the present disclosure, but are not intended to limit the scope of the present disclosure.

A person skilled in the art may understand that the terms such as “first” and “second” in the embodiments of the present disclosure are only used to distinguish different steps, devices or modules, etc., and do not represent any specific technical meaning or an inevitable logical sequence therebetween.

It should be noted that, unless otherwise stated specifically, relative arrangement of the components and steps, the numerical expressions, and the values set forth in the embodiments are not intended to limit the scope of the present disclosure.

In addition, it should be understood that, for ease of description, a size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to electronic devices such as terminal devices, computer systems, and servers, which may operate with numerous other general-purpose or special-purpose computing system environments or configurations. Examples of well-known terminal devices, computing systems, environments, and/or configurations suitable for use together with the electronic devices such as terminal devices, computer systems, and servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems, and the like.

The electronic devices such as terminal devices, computer systems, and servers may be described in the general context of computer system executable instructions (such as, program modules) executed by the computer system. Generally, the program modules may include routines, programs, target programs, components, logics, data structures, and the like, to perform specific tasks or implement specific abstract data types. The computer system/server may be practiced in the distributed cloud computing environments in which tasks are executed by remote processing devices that are linked through a communications network. In the distributed computing environments, program modules may be located in local or remote computing system storage medium including storage devices.

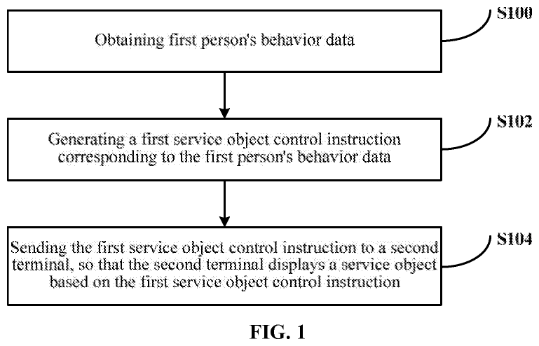

Referring to FIG. 1, a flowchart of a method for operating a service object according to an embodiment of the present disclosure is shown. The method for operating a service object according to each embodiment of the present disclosure may be executed by any device having data acquisition, processing and transmission functions, including, but not limited to, a terminal device, a PC, and the like. To facilitate understanding of a service object operation solution provided in an embodiment of the present disclosure, in this embodiment, by taking a live video scenario as an example scenario, and a viewer terminal in the live video scenario as an executor for the method for operating a service object according to this embodiment, the method for operating a service object according to this embodiment is described. However, a person skilled in the art should understand that, in other video scenarios, such as a video call scenario, other devices having data acquisition, processing and transmission functions may implement the method for operating a service object provided in the embodiments of the present disclosure with reference to this embodiment. The embodiments of the present disclosure do not limit the implementation scenario. As shown in FIG. 1, the method for operating a service object according to this embodiment includes the following steps.

Step S100, first person's behavior data is obtained.

In this embodiment, the first person's behavior data may be considered to be behavior data of a first terminal user obtained by a first terminal, and the first person's behavior data may be data generated by a behavior of the first terminal user. The first person's behavior data may be obtained by the first terminal, or the first person's behavior data may further be obtained by an associated device of the first terminal. This embodiment does not limit the technical means used for obtaining the first person's behavior data.

In an optional example, step S100 may be performed by a processor by invoking a corresponding instruction stored in a memory, and may also be performed by a first obtaining module 600 run by the processor.

Step S102, a first service object control instruction corresponding to the first person's behavior data is generated.

The first service object control instruction may be generated according to a correspondence between the first person's behavior data and the first service object control instruction. The correspondence may be stored in the first terminal locally, or may further be stored at a server side, and the correspondence is obtained from the server side by the first terminal, and is stored in the first terminal locally.

In an optional example, step S102 may be performed by a processor by invoking a corresponding instruction stored in a memory, and may also be performed by a first generating module 602 run by the processor.

Step S104, the first service object control instruction is sent to a second terminal, so that the second terminal displays a service object based on the first service object control instruction.

After generating the first service object control instruction, the first terminal sends the first service object control instruction to the second terminal. The first service object control instruction is used for displaying the service object on the second terminal.

In an optional example, step S104 may be performed by a processor by invoking a corresponding instruction stored in a memory, and may also be performed by a first sending module 604 run by the processor.

According to the technical solution provided in this embodiment, the first person's behavior data is obtained on the first terminal, the first person's behavior data being person's behavior data of the first terminal user, the first service object control instruction corresponding to the first person's behavior data is generated, and the first service object control instruction is sent to the second terminal, so that the second terminal displays the service object based on the first service object control instruction, thereby implementing the process of generating and sending the first service object control instruction on the first terminal, and displaying the service object on the second terminal based on the first service object control instruction.

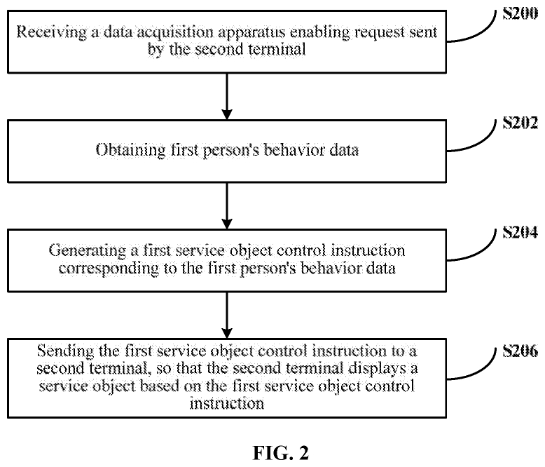

Referring to FIG. 2, a flowchart of another method for operating a service object according to an embodiment of the present disclosure is shown. In this embodiment, by still taking a viewer terminal in a live video scenario as an example, the method for operating a service object provided in this embodiment is described. The operation method may be executed by other devices in other scenarios with reference to this embodiment. As shown in FIG. 2, the method for operating a service object according to this embodiment includes the following steps.

Step S200, a data acquisition apparatus enabling request sent by a second terminal is received.

In this embodiment, the second terminal may be a host terminal in the live video scenario. The second terminal sends the data acquisition apparatus enabling request to a first terminal, where a data acquisition apparatus may be a data acquisition apparatus of the first terminal, or may further be a data acquisition apparatus of an associated device of the first terminal.

In an optional example, step S200 may be performed by a processor by invoking a corresponding instruction stored in a memory, and may also be performed by a first receiving module 706 run by the processor.

Step S202, first person's behavior data is obtained.

According to one or more embodiments of the present disclosure, in a feasible implementation mode, the first person's behavior data is obtained when a user confirmation operation based on the data acquisition apparatus enabling request sent by the second terminal is detected on the first terminal. The user confirmation operation may be an operation input on the first terminal by a user, for example, pressing a “confirm” button on a display screen of the first terminal. This embodiment does not limit the operation form of the user confirmation operation.

In this embodiment, a feasible implementation mode of obtaining first person's behavior data is: obtaining the first person's behavior data by a data acquisition apparatus; the data acquisition apparatus may be a data acquisition apparatus of the first terminal, or a data acquisition apparatus of a smart device associated with the first terminal. The data acquisition apparatus may include any one or any combination of: a video image acquisition apparatus, an infrared data acquisition apparatus, and an ultrasonic data acquisition apparatus; the video image acquisition apparatus may include a camera of the first terminal. The smart device associated with the first terminal in each embodiment of the present disclosure may be smartphone, a tablet computer, a smart television, and the like. This embodiment does not limit the type and model of the smart device associated with the first terminal.

In each embodiment of the present disclosure, the first person's behavior data may include, but is not limited to, any one or any combination of body movement data, gesture movement data, facial movement data, and facial expression data. The first person's behavior data in each embodiment of the present disclosure is not limited to conventional text data or voice data, so as to provide novel interaction data for the interaction between the first terminal and the second terminal.

In an optional example, step S204 may be performed by a processor by invoking a corresponding instruction stored in a memory, and may also be performed by a first generating module 702 run by the processor.

Step S204, a first service object control instruction corresponding to the first person's behavior data is generated.

According to one or more embodiments of the present disclosure, in a feasible implementation mode, whether the first person's behavior data matches trigger data for a preset service object starting instruction may be determined, and the first service object control instruction is generated when the first person's behavior data matches the trigger data for the preset service object starting instruction. For example, if the first person's behavior data is “hand-waving” data in the gesture movement data, and the trigger data for the preset service object starting instruction is also “hand-waving” data, it is determined that the first person's behavior data matches the trigger data for the preset service object starting instruction. Prompt information for the result indicating that the first person's behavior data does not match the trigger data for the preset service object starting instruction may be displayed on the first terminal when the first person's behavior data does not match the trigger data for the preset service object starting instruction, for example, if the first person's behavior data is “hand-waving” data in the gesture movement data, and the trigger data for the preset service object starting instruction is “fist-making” data, it is determined that the first person's behavior data does not match the trigger data for the preset service object starting instruction.

In an optional example, the step S204 may be performed by a processor by invoking a corresponding instruction stored in a memory, and may also be performed by a first obtaining module 700 run by the processor.

Step S206, the first service object control instruction is sent to the second terminal, so that the second terminal displays a service object based on the first service object control instruction.

The service object in each embodiment of the present disclosure may be a game. By means of this embodiment, a game may be displayed on the second terminal according to the first service object control instruction generated on the first terminal.

In an optional example, step S206 may be performed by a processor by invoking a corresponding instruction stored in a memory, and may also be performed by a first sending module 704 run by the processor.

According to the technical solution provided in this embodiment, the first person's behavior data is obtained on the first terminal, the first person's behavior data being person's behavior data of a first terminal user, the first service object control instruction corresponding to the first person's behavior data is generated, and the first service object control instruction is sent to a second terminal, so that the second terminal displays a service object based on the first service object control instruction, thereby implementing the process of generating and sending the first service object control instruction on the first terminal, and displaying the service object on the second terminal based on the first service object control instruction.

According to this embodiment, when obtaining the first person's behavior data, the first person's behavior data may be obtained by the data acquisition apparatus of the first terminal or the data acquisition apparatus of the smart device associated with the first terminal, thereby expanding the obtaining range for the first person's behavior data and increasing the obtaining means for the first person's behavior data, and improving the flexibility of obtaining the first person's behavior data.

The data acquisition apparatus in this embodiment may be any one or any combination of: a video image acquisition apparatus, an infrared data acquisition apparatus, and an ultrasonic data acquisition apparatus; different types of first person's behavior data may be obtained by various video image acquisition apparatuses.

According to this embodiment, before the first person's behavior data is obtained, a data acquisition apparatus enabling request sent by the second terminal may be received, and the user confirmation operation is detected, i.e., the first person's behavior data is obtained in the case that the data acquisition apparatus enabling request is initiated by the second terminal and the data acquisition apparatus enabling request is confirmed, so that the security of the first person's behavior data is improved.

According to this embodiment, whether the obtained first person's behavior data matches the trigger data for the preset service object starting instruction is determined; if yes, a service object starting instruction is generated; and if not, no service object starting instruction is generated.

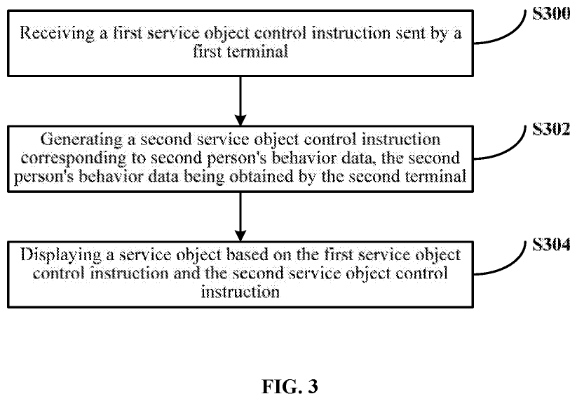

Referring to FIG. 3, a flowchart of still another method for operating a service object according to an embodiment of the present disclosure is shown.

According to this embodiment, taking a host terminal in a live video scenario as an example, the method for operating a service object provided in this embodiment is described. The operation method may be executed by other devices in other scenarios with reference to this embodiment. As shown in FIG. 3, the method for operating a service object according to this embodiment includes the following steps.

Step S300, a first service object control instruction sent by a first terminal is received.

In this embodiment, the first terminal may be considered to be a viewer terminal in the live video scenario. The description on the first service object control instruction may be made with reference to the content in the foregoing embodiment, and details are not described herein again.

In an optional example, step S300 may be performed by a processor by invoking a corresponding instruction stored in a memory, and may also be performed by a second receiving module 800 run by the processor.

Step S302, a second service object control instruction corresponding to second person's behavior data is generated, the second person's behavior data being obtained by the second terminal.

In this embodiment, the second terminal may be considered to be the host terminal in the live video scenario. The process of generating the second service object control instruction may be implemented with reference to the process of generating the first service object control instruction in the foregoing embodiments, and details are not described herein again.

In an optional example, step S302 may be performed by a processor by invoking a corresponding instruction stored in a memory, and may also be performed by a second generating module 802 run by the processor.

Step S304, a service object is displayed based on the first service object control instruction and the second service object control instruction.

In this embodiment, the service object is displayed on the second terminal based on the first service object control instruction sent by the first terminal and the second service object control instruction generated on the second terminal.

In an optional example, step S304 may be performed by a processor by invoking a corresponding instruction stored in a memory, and may also be performed by a service object displaying module 804 run by the processor.

According to the technical solution provided in this embodiment, the first service object control instruction generated by the first terminal is received on the second terminal, the second person's behavior data is obtained, the second first service object control instruction corresponding to the second person's behavior data is generated, and the service object is displayed based on the first service object control instruction and the second service object control instruction. According to this embodiment, by receiving the first service object control instruction from the first terminal by the second terminal, an interaction process of displaying the service object by the second terminal according to the received first service object control instruction and the generated second service object control instruction is implemented. Therefore, intelligent interaction between the first terminal and the second terminal is implemented, interaction modes between the terminals are enriched, interaction flexibility is improved, and interaction requirements for a first terminal user and/or a second terminal user are satisfied.

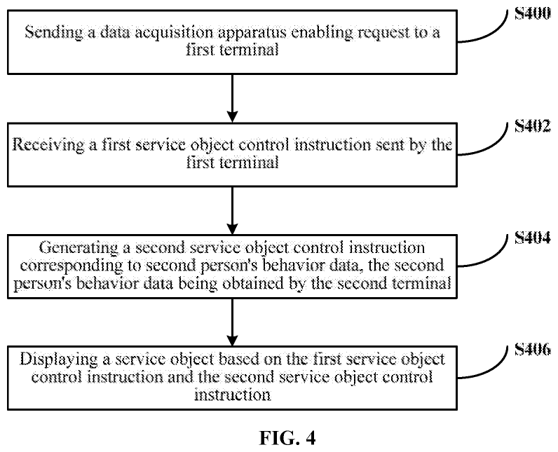

Referring to FIG. 4, a flowchart of yet another method for operating a service object according to an embodiment of the present disclosure is shown. In this embodiment, still by taking a host terminal in a live video scenario as an example, the method for operating a service object provided in this embodiment is described. The operation method may be executed by other devices in other scenarios with reference to this embodiment. As shown in FIG. 4, the method for operating a service object according to this embodiment includes the following steps.

Step S400, a data acquisition apparatus enabling request is sent to a first terminal.

In this embodiment, the first terminal may be considered to be a viewer terminal in a live video scenario; the data acquisition apparatus enabling request is used for enabling a data acquisition apparatus corresponding to the first terminal. The data acquisition apparatus enabling request is sent to the first terminal, so as to detect a user confirmation operation on a first terminal device; the first terminal obtains first person's behavior data, and generates a first service object control instruction corresponding to the first person's behavior data.

In an optional example, step S400 may be performed by a processor by invoking a corresponding instruction stored in a memory, and may also be performed by a second sending module 912 run by the processor.

Step S402, the first service object control instruction sent by the first terminal is received.

The description related to the first service object control instruction may be made with reference to the content in the foregoing embodiment, and details are not described herein again.

In an optional example, step S402 may be performed by a processor by invoking a corresponding instruction stored in a memory, and may also be performed by a second receiving module 900 run by the processor.

Step S404, a second service object control instruction corresponding to second person's behavior data is generated, the second person's behavior data being obtained by a second terminal.

In this embodiment, the second terminal may be considered to be the host terminal in the live video scenario. The process of generating the second service object control instruction and the process of obtaining the second person's behavior data may be implemented with reference to the process of generating the first service object control instruction and the process of obtaining the first person's behavior data in the foregoing embodiments, and details are not described herein again.

It should be noted that, during the process of generating the second service object control instruction corresponding to the second person's behavior data, whether the second person's behavior data matches a preset control behavior for a service object is determined, the second service object control instruction is generated when the second person's behavior data matches the preset control behavior for the service object, and prompt information for the result indicating that the second person's behavior data does not match the preset control behavior for the service object may be displayed on the second terminal when the second person's behavior data does not match the preset control behavior for the service object.

In an optional example, step S404 may be performed by a processor by invoking a corresponding instruction stored in a memory, and may also be performed by a second generating module 902 run by the processor.

Step S406, the service object is displayed based on the first service object control instruction and the second service object control instruction.

In this embodiment, the service object is displayed on the second terminal based on the first service object control instruction sent by the first terminal and the second service object control instruction generated on the second terminal.

In an optional example, step S400 may be performed by a processor by invoking a corresponding instruction stored in a memory, and may also be performed by a service object displaying module 904 run by the processor.

According to one or more embodiments of the present disclosure, in a feasible implementation mode, the service object may be a game. Step S406 may include: obtaining a first operation result corresponding to the first service object control instruction, and a second operation result corresponding to the second service object control instruction; and displaying the first operation result and the second operation result. The service object in this embodiment is the first operation result and the second operation result. For example, the game is a bowling game; the first service object control instruction is an instruction for starting the bowling game, and the first operation result corresponding to the first service object control instruction is that bowling pins are ready and wait to be hit; the second service object control instruction is a hitting instruction, and the second operation result corresponding to the second service object control instruction is that hitting ends and three bowling pins are knocked down; and the first operation result that “the bowling pins are put in place and wait to be bit” and the second operation result that “hitting ends and three bowling pins are knocked down” are displayed in sequence on the second terminal. According to one or more embodiments of the present disclosure, in a feasible implementation mode, first behavior data and second behavior data may further be displayed while the service object is displayed; the first behavior data is behavior data corresponding to the first operation result, and the second behavior data is behavior data corresponding to the second operation result. For example, the first behavior data is arranging the bowling pins, and the second behavior data is hitting.

According to one or more embodiments of the present disclosure, in a feasible implementation mode, when the service object is displayed, the service object may be displayed in the alternative in the following modes.

Mode I, the service object and a current video image are displayed in a split-screen manner.

The current video image may be a video image currently displayed on a second terminal device, and according to different application scenarios of this embodiment, the current video image may be a live video image or a video call image, etc.

The service object and the current video image are displayed in the split-screen manner, which may be a left-right split-screen manner or an up-down split-screen manner, and the display ratio of the service object and the current video image may be set according to actual situations. This embodiment does not limit the split-screen display mode and the split-screen display ratio.

Mode II, the service object and the current video image are displayed in a picture-in-picture manner.

In mode II, the display size of the current video image may be less than that of the service object. Moreover, the current video image may be arranged at the upper left corner, the upper right corner, the lower left corner or the lower right of the screen of the second terminal. This embodiment does not limit the optional position of the current video image.

According to the technical solution provided in this embodiment, the first service object control instruction generated by the first terminal is received on the second terminal, the second person's behavior data is obtained, the second first service object control instruction corresponding to the second person's behavior data is generated, and the service object is displayed based on the first service object control instruction and the second service object control instruction. According to this embodiment, by receiving the first service object control instruction from the first terminal by the second terminal, an interaction process of displaying the service object by the second terminal according to the received first service object control instruction and the generated second service object control instruction is implemented. Therefore, intelligent interaction between the first terminal and the second terminal is implemented, interaction modes between the terminals are enriched, interaction flexibility is improved, and interaction requirements for a first terminal user and/or a second terminal user are satisfied.

According to this embodiment, when obtaining the second person's behavior data, the second person's behavior data may be obtained by the data acquisition apparatus of the second terminal or the data acquisition apparatus of the smart device associated with the second terminal, thereby expanding the obtaining range for the second person's behavior data and increasing the obtaining means for the second person's behavior data, and improving the flexibility of obtaining the second person's behavior data.

The data acquisition apparatus in each embodiment of the present disclosure, for example, may include, but is not limited to, any one or any combination of: a video image acquisition apparatus, an infrared data acquisition apparatus, and an ultrasonic data acquisition apparatus; different types of second person's behavior data may be obtained by various video image acquisition apparatuses. The video image acquisition apparatus may include a camera of the second terminal.

According to this embodiment, before the first service object control instruction is received, it is required to send the data acquisition apparatus enabling request to the first terminal, thereby improving the security of generating the first service object control instruction by the first terminal.

The second person's behavior data in this embodiment includes any one or any combination of body movement data, gesture movement data, facial movement data, and facial expression data, and is not limited to conventional text data or voice data, so as to provide novel interaction data for interaction between the first terminal and the second terminal.

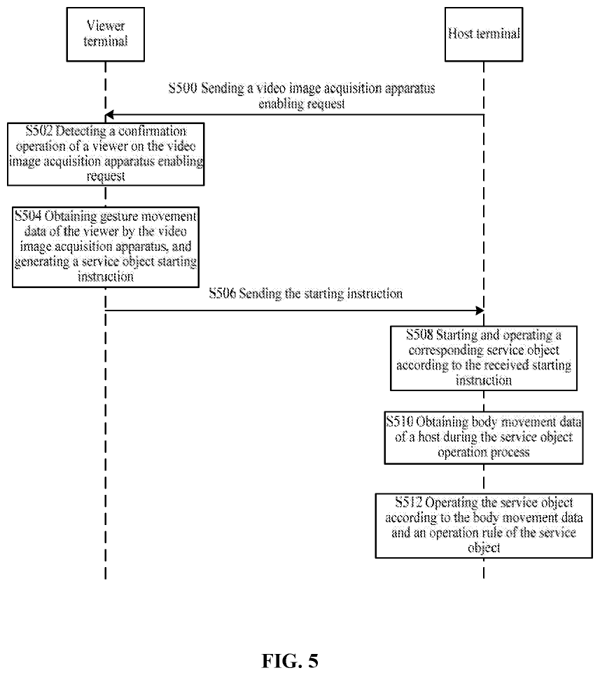

Referring to FIG. 5, a flowchart of still yet another method for operating a service object according to an embodiment of the present disclosure is shown. According to this embodiment, description is made by still taking a live video scenario as an example. This embodiment relates to two executors, which are a host terminal and a viewer terminal respectively. As shown in FIG. 5, the method for operating a service object according to this embodiment includes the following steps.

Step S500, a host terminal sends a video image acquisition apparatus enabling request to a viewer terminal.

The video image acquisition apparatus in each embodiment of the present disclosure may be a camera, and may optionally a front-facing camera, a rear-facing camera, or a third-party camera, etc.

Step S502, the viewer terminal detects a confirmation operation of a viewer on the video image acquisition apparatus enabling request.

According to this embodiment, by performing steps S500 and S502, a request process of enabling the video image acquisition apparatus of the viewer terminal is added, thereby improving the security of enabling the video image acquisition apparatus of the viewer terminal.

Step S504, the viewer terminal obtains gesture movement data of the viewer by the video image acquisition apparatus, and generates a service object starting instruction.

For example, V-gesture data of the viewer is obtained by the front-facing camera of the viewer terminal, and the service object starting instruction, i.e., a first service object control instruction, is generated according to the V-gesture data.

In this embodiment, the technical means used for generating the service object starting instruction may be implemented with reference to the description on the generation of the service object control instruction in the foregoing embodiment, and details are not described herein again.

Step S506, the viewer terminal sends the starting instruction to the host terminal.

Step S508, the host terminal starts and operates a corresponding service object according to the received starting instruction.

The host terminal starts and operates the service object, and the service object may be displayed on the host terminal in a full-screen manner.

After the host terminal receives the starting instruction, the host terminal may obtain a service object to be run from a server or the viewer terminal first. The service object may include an operation rule of the service object.

If there is a current video image, such as a video image captured by a host in real time or a video image being played back, on the host terminal, the display mode, such as split-screen display or picture-in-picture display, of the service object and the video image may be further adjusted. This embodiment does not limit the optional display mode of the service object and the video image.

Step S510, during the service object running process, the host terminal obtains body movement data of the host.

The host terminal may obtain, by the front-facing camera thereof or an external camera, the video image of the host, and detects the body movement data of the host from the video image of the host.

Step S512, the host terminal operates the service object according to the body movement data and the operation rule of the service object.

When the service object is operated, optional body movement data may be set according to the operation rule of the service object, for example, the operation rule of the service object includes controlling the movement of a box according to a pushing action of the host, and then the box in the service object needs to be controlled according to the hand action data of the host.

Based on the method for operating a service object, by taking as an example that the service object is a game, a game interaction scheme between the host terminal and the viewer terminal is introduced. The viewer terminal initiates a game starting instruction to the host terminal, and the host terminal starts and operates a game according to the starting instruction. During the game running process, the host terminal obtains the video image of the host, and detects gesture data of the host from the video image, and the host terminal operates the game according to the gesture data of the host and an operation rule of the game. For example, when the gesture of the host is a hand-holding gesture, a horizontal flat panel is displayed on an operation interface of the game; when the hand-holding gesture of the host moves upwards, downwards, leftwards or rightwards, the horizontal flat panel in the operation interface of the game correspondingly moves upwards, downwards, leftwards or rightwards, and the host may control the position of the horizontal flat panel in the game by changing the position of the hand-holding gesture, and catches, by using the horizontal flat panel, articles falling down from top to bottom. After the game ends, the number of the articles caught by the host may be displayed. The game may be an independent application, and is invoked and started after a starting instruction is received; the game may also be a component program in an embedded live application, and is invoked and started after a starting instruction is received. The embodiments of the present disclosure do not limit the form of existence and the invocation and starting form of the service object.

In addition, according to this embodiment, based on a video playback process, a series of operations such as obtaining the starting instruction, starting the operation of the service object, obtaining the video image, detecting action detection data, and operating the service object are performed during the video playback process, thereby fully utilizing live video interaction resources.

In the live video scenario, the video image of the host is obtained in real time by the camera of the host terminal; action detection data, e.g., expression such as crying, smelling or frowning and gestures such as V gesture and OK gesture, of the host is detected in real time from the video image of the host by means of a face recognition technology or a gesture recognition technology; the action detection data is used as an input item of service object operation, and there is no need to configure an additional data detection apparatus on the host terminal, thereby reducing the hardware costs of service object operation, and improving the convenience of service object operation.

Any image processing method provided in the embodiments of the present disclosure may be executed by any appropriate device having data processing capability, including, but not limited to, a terminal and a server, etc. Alternatively, any method for operating a service object provided in the embodiments of the present disclosure may be executed by a processor, for example, any method for operating a service object mentioned in the embodiments of the present disclosure is executed by the processor by invoking corresponding instruction stored in a memory. Details are not described below again.

A person of ordinary skill in the art may understand that all or some steps of implementing the forgoing embodiments of the method may be achieved by a program by instructing related hardware; the foregoing program may be stored in a computer-readable storage medium; when the program is executed, steps including the foregoing embodiments of the method are performed. Moreover, the foregoing storage medium includes various medium capable of storing program codes such as ROM, RAM, a magnetic disk, or an optical disk.

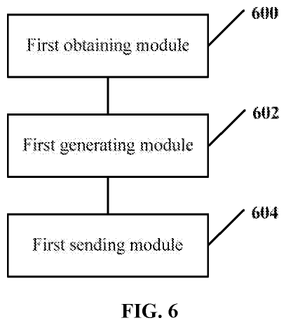

Referring to FIG. 6, a structural block diagram of an apparatus for operating a service object according to an embodiment of the present disclosure is shown.

The apparatus for operating a service object in this embodiment is used in a first terminal. The operation apparatus includes: a first obtaining module 600, configured to obtain first person's behavior data; a first generating module 602, configured to generate a first service object control instruction corresponding to the first person's behavior data; and a first sending module 604, configured to send the first service object control instruction to a second terminal, so that the second terminal displays a service object based on the first service object control instruction.

According to the technical solution provided in this embodiment, the first person's behavior data is obtained on the first terminal, the first person's behavior data being person's behavior data of a first terminal user, the first service object control instruction corresponding to the first person's behavior data is generated, and the first service object control instruction is sent to the second terminal, so that the second terminal displays the service object based on the first service object control instruction, thereby implementing the process of generating and sending the first service object control instruction on the first terminal, and displaying the service object on the second terminal based on the first service object control instruction.

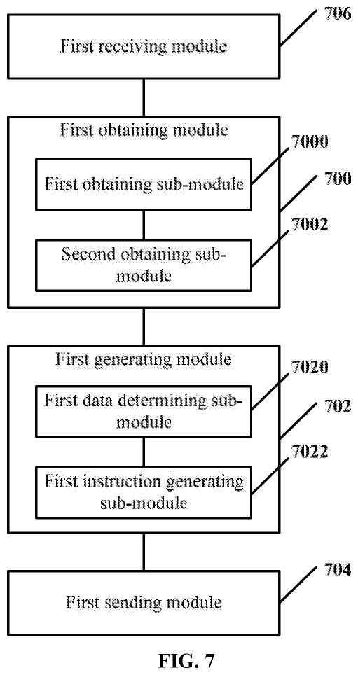

Referring to FIG. 7, a structural block diagram of another apparatus for operating a service object according to an embodiment of the present disclosure is shown.

The apparatus for operating a service object in this embodiment is used in a first terminal. The operation apparatus includes: a first obtaining module 700, configured to obtain first person's behavior data; a first generating module 702, configured to generate a first service object control instruction corresponding to the first person's behavior data; and a first sending module 704, configured to send the first service object control instruction to a second terminal, so that the second terminal displays a service object based on the first service object control instruction.

According to one or more embodiments of the present disclosure, the first obtaining module 700 includes: a first obtaining sub-module 7000, configured to obtain the first person's behavior data by a data acquisition apparatus; the data acquisition apparatus is a data acquisition apparatus of a first terminal, or a data acquisition apparatus of a smart device associated with the first terminal.

According to one or more embodiments of the present disclosure, the data acquisition apparatus may include any one or any combination of: a video image acquisition apparatus, an infrared data acquisition apparatus, and an ultrasonic data acquisition apparatus; the video image acquisition apparatus includes a camera of the first terminal.

According to one or more embodiments of the present disclosure, the apparatus for operating a service object provided in this embodiment may further include: a first receiving module 706, configured to receive, before the first obtaining module 700 obtains first person's behavior data, a data acquisition apparatus enabling request sent by the second terminal.

According to one or more embodiments of the present disclosure, the first obtaining module 700 includes: a second obtaining sub-module 7002, configured to obtain the first person's behavior data when a user confirmation operation based on the data acquisition apparatus enabling request is detected.

According to one or more embodiments of the present disclosure, the first generating module 702 includes: a first data determining sub-module 7020, configured to determine whether the first person's behavior data matches trigger data for a preset service object starting instruction; and a first instruction generating sub-module 7022, configured to generate the first service object control instruction when the first person's behavior data matches the trigger data for the preset service object starting instruction.

According to one or more embodiments of the present disclosure, the first person's behavior data, for example, may include, but is not limited to, any one or any combination of: body movement data, gesture movement data, facial movement data, and facial expression data.

According to one or more embodiments of the present disclosure, the service object, for example, may include a game.

According to the technical solution provided in this embodiment, the first person's behavior data is obtained on the first terminal, the first person's behavior data being person's behavior data of a first terminal user, the first service object control instruction corresponding to the first person's behavior data is generated, and the first service object control instruction is sent to the second terminal, so that the second terminal displays the service object based on the first service object control instruction, thereby implementing the process of generating and sending the first service object control instruction on the first terminal, and displaying the service object on the second terminal based on the first service object control instruction.

According to this embodiment, when obtaining the first person's behavior data, the first person's behavior data may be obtained by the data acquisition apparatus of the first terminal or the data acquisition apparatus of the smart device associated with the first terminal, thereby expanding the obtaining range for the first person's behavior data and increasing the obtaining means for the first person's behavior data, and improving the flexibility of obtaining the first person's behavior data.

The data acquisition apparatus in this embodiment may be any one or any combination of a video image acquisition apparatus, an infrared data acquisition apparatus, and an ultrasonic data acquisition apparatus; different types of first person's behavior data may be obtained by various video image acquisition apparatuses.

According to this embodiment, before the first person's behavior data is obtained, it is required to receive a data acquisition apparatus enabling request sent by the second terminal, and the user confirmation operation is detected, i.e., the first person's behavior data is obtained in the case that the data acquisition apparatus enabling request is initiated by the second terminal and the data acquisition apparatus enabling request is confirmed, so that the security of the first person's behavior data is improved.

According to this embodiment, whether the obtained first person's behavior data matches the trigger data for the preset service object starting instruction is determined; if yes, a service object starting instruction is generated; and if not, no service object starting instruction is generated.

The first person's behavior data in this embodiment includes any one or any combination of body movement data, gesture movement data, facial movement data, and facial expression data, and is not limited to conventional text data or voice data, so as to provide novel interaction data for interaction between the first terminal and the second terminal.

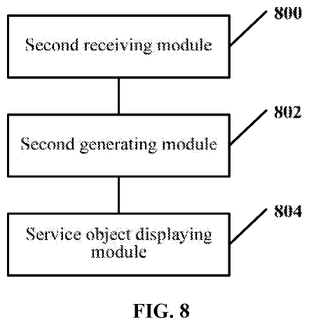

Referring to FIG. 8, a structural block diagram of still another apparatus for operating a service object according to an embodiment of the present disclosure is shown.

The apparatus for operating a service object in this embodiment is used in a second terminal. The operation apparatus includes: a second receiving module 800, configured to receive a first service object control instruction sent by a first terminal; a second generating module 802, configured to generate a second service object control instruction corresponding to second person's behavior data, the second person's behavior data being obtained by the second terminal; and a service object displaying module 804, configured to display a service object based on the first service object control instruction and the second service object control instruction.

According to the technical solution provided in this embodiment, the first service object control instruction generated by the first terminal is received on the second terminal, the second person's behavior data is obtained, and the second first service object control instruction corresponding to the second person's behavior data is generated, and the service object is displayed based on the first service object control instruction and the second service object control instruction. According to this embodiment, by receiving the first service object control instruction from the first terminal by the second terminal, an interaction process of displaying the service object by the second terminal according to the received first service object control instruction and the generated second service object control instruction is implemented, thereby implementing intelligent interaction between the first terminal and the second terminal, enriching the interaction modes between the terminals, improving interaction flexibility, and satisfying interaction requirements for a first terminal user and/or a second terminal user.

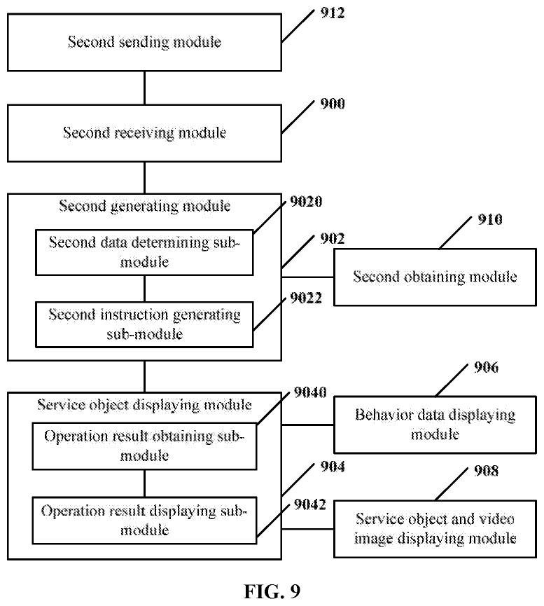

Referring to FIG. 9, a structural block diagram of yet another apparatus for operating a service object according to an embodiment of the present disclosure is shown.

The apparatus for operating a service object in this embodiment is used in a second terminal. The operation apparatus includes: a second receiving module 900, configured to receive a first service object control instruction sent by a first terminal; a second generating module 902, configured to generate a second service object control instruction corresponding to second person's behavior data, the second person's behavior data being obtained by the second terminal; and a service object displaying module 904, configured to display a service object based on the first service object control instruction and the second service object control instruction.

According to one or more embodiments of the present disclosure, the service object displaying module 904 includes: an operation result obtaining sub-module 9040, configured to obtain a first operation result corresponding to the first service object control instruction, and a second operation result corresponding to the second service object control instruction; and an operation result displaying sub-module 9042, configured to display the first operation result and the second operation result.

According to one or more embodiments of the present disclosure, the apparatus for operating a service object provided in this embodiment further includes: a behavior data displaying module 906, configured to display first behavior data and second behavior data, the first behavior data being behavior data corresponding to the first operation result, and the second behavior data being behavior data corresponding to the second operation result.

According to one or more embodiments of the present disclosure, the apparatus for operating a service object provided in this embodiment further includes: a service object and video image displaying module 908, configured to display the service object and a current video image in a split-screen manner; or to display the service object and the current video image in a picture-in-picture manner, the display size of the current video image being less than that of the service object.

According to one or more embodiments of the present disclosure, the apparatus for operating a service object provided in this embodiment further includes: a second obtaining module 910, configured to obtain the second person's behavior data by a data acquisition apparatus; the data acquisition apparatus is a data acquisition apparatus of a second terminal, or a data acquisition apparatus of a smart device associated with the second terminal.

According to one or more embodiments of the present disclosure, the data acquisition apparatus, for example, may include, but is not limited to, any one or any combination of: a video image acquisition apparatus, an infrared data acquisition apparatus, and an ultrasonic data acquisition apparatus; the video image acquisition apparatus includes a camera of the second terminal.

According to one or more embodiments of the present disclosure, the apparatus for operating a service object provided in this embodiment may further include: a second sending module 912, configured to send, before the second receiving module 900 receives a first service object control instruction sent by a first terminal, a data acquisition apparatus enabling request to the first terminal, the data acquisition apparatus enabling request being used for enabling a data acquisition apparatus corresponding to the first terminal.

According to one or more embodiments of the present disclosure, the second generating module 902 includes: a second data determining sub-module 9020, configured to determine whether the second person's behavior data matches a preset control behavior for the service object; and a second instruction generating sub-module 9022, configured to generate the second service object control instruction when the second person's behavior data matches the preset control behavior for the service object.

According to one or more embodiments of the present disclosure, the second person's behavior data, for example, may include, but is not limited to, any one or any combination of: body movement data, gesture movement data, facial movement data, and facial expression data.

According to one or more embodiments of the present disclosure, the service object, for example, may include a game.

According to the technical solution provided in this embodiment, the first service object control instruction generated by the first terminal is received on the second terminal, the second person's behavior data is obtained, the second first service object control instruction corresponding to the second person's behavior data is generated, and the service object is displayed based on the first service object control instruction and the second service object control instruction. According to this embodiment, by receiving the first service object control instruction from the first terminal by the second terminal, an interaction process of displaying the service object by the second terminal according to the received first service object control instruction and the generated second service object control instruction is implemented, thereby implementing intelligent interaction between the first terminal and the second terminal, enriching the interaction modes between the terminals, improving interaction flexibility, and satisfying interaction requirements for a first terminal user and/or a second terminal user.

According to this embodiment, when obtaining the second person's behavior data, the second person's behavior data may be obtained by the data acquisition apparatus of the second terminal or the data acquisition apparatus of the smart device associated with the second terminal, thereby expanding the obtaining range for the second person's behavior data and increasing the obtaining means for the second person's behavior data, and improving the flexibility of obtaining the second person's behavior data.

The data acquisition apparatus in this embodiment, for example, may include, but is not limited to, any one or any combination of: a video image acquisition apparatus, an infrared data acquisition apparatus, and an ultrasonic data acquisition apparatus; different types of second person's behavior data may be obtained by various video image acquisition apparatuses.

According to this embodiment, before the first service object control instruction is received, it is required to send the data acquisition apparatus enabling request to the first terminal, thereby improving the security of generating the first service object control instruction by the first terminal.

The second person's behavior data in this embodiment includes any one or any combination of body movement data, gesture movement data, facial movement data, and facial expression data, and is not limited to conventional text data or voice data, so as to provide novel interaction data for interaction between the first terminal and the second terminal.

In addition, an embodiment of the present disclosure further provides an electronic device, including a processor and a memory;

the memory is configured to store at least one executable instruction, where the executable instruction enables the processor to perform corresponding operations of the method for operating a service object according to any one of the embodiments of the present disclosure.

In addition, an embodiment of the present disclosure further provides another electronic device, including:

a processor and the apparatus for operating a service object according to any one of the embodiments of the present disclosure, when the processor runs the apparatus for operating a service object, the units in the apparatus for operating a service object according to any one of the embodiments of the present disclosure are run.

Each embodiment of the present disclosure further provides an electronic device which, for example, may be a mobile terminal, a personal computer (PC), a tablet computer, a server, and the like.

In addition, an embodiment of the present disclosure further provides a computer program, including a computer-readable code, where when the computer-readable code is running on a device, a processor in the device executes instructions for implementing the steps of the method for operating a service object according to any one of the embodiments of the present disclosure.

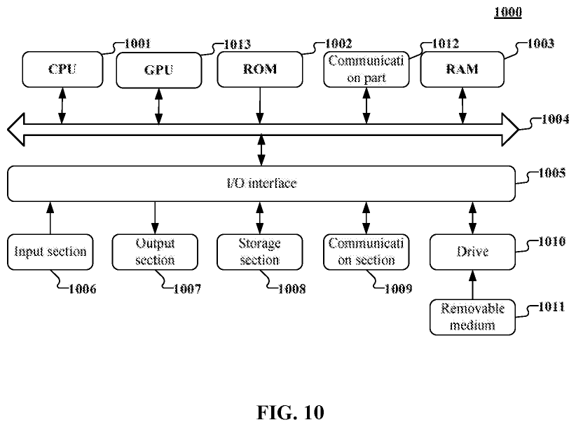

In addition, an embodiment of the present disclosure further provides a computer-readable storage medium, configured to store computer-readable instructions, where when the instructions are executed, the operations in the steps of the method for operating a service object according to any one of the embodiments of the present disclosure are implemented. FIG. 10 is a schematic structural diagram of an application embodiment of an electronic device according to an embodiment of the present disclosure. An electronic device 1000 according to the embodiment as shown in FIG. 10 may be suitable for implementing the first terminal, the second terminal, or the server according to the embodiments of the present disclosure. As shown in FIG. 10, the electronic device 1000 includes one or more processors, a communication part, and the like. The one or more processors are, for example, one or more central processing units (CPUs) 1001, and/or one or more graphic processing units (GPUs) 1013, and the like. The processor may perform various appropriate actions and processing according to executable instructions stored in a read-only memory (ROM) 1002 or executable instructions loaded from a storage section 1008 to a random access memory (RAM) 1003. The communication part 1012 may include, but is not limited to, a network card. The network card may include, but is not limited to, an Infiniband (IB) network card.

The processor may communicate with the ROM 1002 and/or the RAM 1030 to execute executable instructions. The processor is connected to the communication part 1012 via a bus 1004, and communicates with other target devices via the communication part 1012, thereby completing corresponding operations of any method provided in the embodiments of the present disclosure, for example, obtaining first person's behavior data, generating a first service object control instruction corresponding to the first person's behavior data, and sending the first service object control instruction to a second terminal, so that the second terminal displays a service object based on the first service object control instruction; for another example, receiving a first service object control instruction sent by a first terminal, generating a second service object control instruction corresponding to second person's behavior data, the second person's behavior data being obtained by the second terminal; and displaying a service object based on the first service object control instruction and the second service object control instruction.

In addition, the RAM 1003 may further store various programs and data required for operations of an apparatus. The CPU 1001, the ROM 1002, and the RAM 1003 are connected to each other via the bus 1004. In the presence of the RAM 1003, the ROM 1002 is an optional module. The RAM 1003 stores executable instructions, or writes executable instructions to the ROM 1002 during running. The executable instructions cause the CPU 1001 to perform corresponding operations of the foregoing method for operating a service object. An input/output (I/O) interface 1005 is also connected to the bus 1004. The communication part 1012 may be integrated, or may be configured to have a plurality of sub-modules (for example, a plurality of IB network cards) connected to the bus.

The following components are connected to the I/O interface 1005: an input section 1006 including a keyboard, a mouse and the like; an output section 1007 including a cathode-ray tube (CRT), a liquid crystal display (LCD), a speaker and the like; the storage section 1008 including a hard disk and the like; and a communication section 1009 of a network interface card including an LAN card, a modem and the like. The communication section 1009 performs communication processing via a network such as the Internet. A drive 1010 is also connected to the I/O interface 1005 according to requirements. A removable medium 1011 such as a magnetic disk, an optical disk, a magneto-optical disk, a semiconductor memory or the like is mounted on the drive 1010 according to requirements, so that a computer program read from the removable medium may be installed on the storage section 1008 according to requirements.

It should be noted that, the architecture shown in FIG. 10 is merely an optional implementation. During specific practice, the number and types of the components in FIG. 10 may be selected, decreased, increased, or replaced according to actual requirements. Different functional components may be separated or integrated or the like. For example, the GPU and the CPU may be separated, or the GPU may be integrated on the CPU, and the communication part may be separated from or integrated on the CPU or the GPU or the like. These alternative implementations all fall within the scope of protection of the present disclosure.

Particularly, the process described above with reference to the flowchart according to an embodiment of the present disclosure may be implemented as a computer software program. For example, an embodiment of the present disclosure includes a computer program product. The computer program product includes a computer program tangibly included in a machine-readable medium. The computer program includes a program code for executing the method shown in the flowchart. The program code may include instructions for executing the corresponding steps of the method according to the embodiments of the present disclosure, for example, obtaining first person's behavior data, generating a first service object control instruction corresponding to the first person's behavior data, and sending the first service object control instruction to a second terminal, so that the second terminal displays a service object based on the first service object control instruction. In such embodiment, the computer program is downloaded and installed from the network through the communication section 1009, and/or is installed from the removable medium 1011. The computer program, when being executed by the CPU 1001, executes the foregoing functions defined in the method of the present disclosure.

The embodiments in the specification are all described in a progressive manner, for same or similar parts in the embodiments, refer to these embodiments, and each embodiment focuses on a difference from other embodiments. The apparatus and device embodiments substantially correspond to the method embodiments and therefore are only described briefly, and for the associated part, refer to the descriptions of the method embodiments. The method, apparatus, and device in the present disclosure may be implemented in many manners. For example, the method, apparatus, and device in the present disclosure may be implemented with software, hardware, firmware, or any combination of software, hardware, and firmware. The foregoing optional sequence of steps of the method is merely for description, and unless otherwise stated particularly, is not intended to limit the steps of the method in the present disclosure. In addition, in some embodiments, the present disclosure may alternatively be implemented as programs recorded in a recording medium. The programs include machine-readable instructions for implementing the method according to the present disclosure. Therefore, the present disclosure further covers the recording medium storing the programs for performing the method according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to enable a person of ordinary skill in the art to understand the present disclosure, so as to design various embodiments with various modifications applicable to particular use.

1. A method for operating a service object, the method comprising:
obtaining, by a first terminal, first person's behavior data;
generating, by the first terminal, a first service object control instruction corresponding to the first person's behavior data; and
sending, by the first terminal, the first service object control instruction to a second terminal.

2. The method according to claim 1, wherein the obtaining, by the first terminal, the first person's behavior data comprises:
obtaining the first person's behavior data by a data acquisition apparatus, the data acquisition apparatus comprising: a data acquisition apparatus of the first terminal, or a data acquisition apparatus of a smart device associated with the first terminal.

3. The method according to claim 2, wherein the data acquisition apparatus comprises at least one of: a video image acquisition apparatus, an infrared data acquisition apparatus, or an ultrasonic data acquisition apparatus; the video image acquisition apparatus comprises a camera of the first terminal.

4. The method according to claim 2, further comprising, before the step of obtaining, by the first terminal, the first person's behavior data,
receiving a data acquisition apparatus enabling request sent by the second terminal, wherein
the step of obtaining, by the first terminal, the first person's behavior data comprises:
obtaining the first person's behavior data when a user confirmation operation based on the data acquisition apparatus enabling request is detected.

5. The method according to claim 1, wherein the generating, by the first terminal, the first service object control instruction corresponding to the first person's behavior data comprises:
determining whether the first person's behavior data matches trigger data for a preset service object starting instruction; and
generating the first service object control instruction when the first person's behavior data matches the trigger data for the preset service object starting instruction.

6. The method according to claim 1, wherein the first person's behavior data comprises at least one of: body movement data, gesture movement data, facial movement data, or facial expression data.

7. The method according to claim 1, wherein the service object comprises a game.

8. A method for operating a service object, the method comprising:
receiving, by a second terminal, a first service object control instruction sent by a first terminal;
generating, by the second terminal, a second service object control instruction corresponding to second person's behavior data, the second person's behavior data being obtained by the second terminal; and
displaying, by the second terminal, the service object based on the first service object control instruction and the second service object control instruction.

9. The method according to claim 8, wherein the step of displaying, by the second terminal, the service object based on the first service object control instruction and the second service object control instruction comprises:
obtaining a first operation result corresponding to the first service object control instruction, and a second operation result corresponding to the second service object control instruction; and
displaying the first operation result and the second operation result.

10. The method according to claim 8, further comprising:
displaying first behavior data and second behavior data, the first behavior data being behavior data corresponding to the first operation result, and the second behavior data being behavior data corresponding to the second operation result.

11. The method according to claim 8, further comprising:
displaying the service object and a current video image in a split-screen manner; or
displaying the service object and the current video image in a picture-in-picture manner, the display size of the current video image being less than that of the service object.

12. The method according to claim 8, further comprising:
obtaining the second person's behavior data by a data acquisition apparatus, the data acquisition apparatus comprising: a data acquisition apparatus of the second terminal, or a data acquisition apparatus of a smart device associated with the second terminal.

13. The method according to claim 12, wherein the data acquisition apparatus comprises at least one of: a video image acquisition apparatus, an infrared data acquisition apparatus, or an ultrasonic data acquisition apparatus; the video image acquisition apparatus comprises a camera of the second terminal.

14. The method according to claim 8, before the step of receiving, by the second terminal, the first service object control instruction sent by the first terminal, further comprising:
sending a data acquisition apparatus enabling request to the first terminal, the data acquisition apparatus enabling request being used for enabling a data acquisition apparatus corresponding to the first terminal.

15. The method according to claim 8, wherein the step of generating, by the second terminal, the second service object control instruction corresponding to the second person's behavior data comprises:
determining whether the second person's behavior data matches a preset control behavior for the service object; and
generating the second service object control instruction when the second person's behavior data matches the preset control behavior for the service object.

16. The method according to claim 8, wherein the second person's behavior data comprises at least one of: body movement data, gesture movement data, facial movement data, or facial expression data.

17. The method according to claim 8, wherein the service object comprises a game.

18.-24. (canceled)

25. A second terminal for operating a service object, the second terminal comprising:
a processor; and
memory for storing instructions executable by the processor;
wherein the processor is configured to:
receive a first service object control instruction sent by a first terminal;
generate a second service object control instruction corresponding to second person's behavior data, the second person's behavior data being obtained by the second terminal; and
display a service object based on the first service object control instruction and the second service object control instruction.

26.-27. (canceled)

28. The second terminal according to claim 25, wherein the processor is further configured to:
display the service object and a current video image in a split-screen manner; or display the service object and the current video image in a picture-in-picture manner, the display size of the current video image being less than that of the service object.

29.-31. (canceled)

32. The second terminal according to claim 25, wherein the processor is further configured to:
determine whether the second person's behavior data matches a preset control behavior for the service object; and
generate the second service object control instruction when the second person's behavior data matches the preset control behavior for the service object.

33.-38. (canceled)
